(19) United States
(12) Patent Application Publication
(10) Pub. No.: US 2011/0302269 A1
(43) Pub. Date: Dec. 8, 2011

(54) FLEXIBLE DATA STRUCTURES AND PROTOCOLS

(75) Inventor: David Keene, San Diego, CA (US)

(73) Assignees: Sony Network Entertainment International LLC, Los Angeles, CA (US); Sony Corporation, Tokyo (JP)

(21) Appl. No.: 12/982,507

(22) Filed: Dec. 30, 2010

Related U.S. Application Data
(60) Provisional application No. 61/352,737, filed on Jun. 8, 2010.

(51) Int. Cl. G06F 15/16

(52) U.S. Cl. 709/217

(57) ABSTRACT

Implementations of the invention provide an API that supports a diverse range of products, and in particular diverse products of highly varying display and UI formfactors. A data template is established at the time of creation of a session, and the same is honored by the NP for the entirety of the browsing experience. In this way, a store experience, e.g., categories and products returned for a query, are customized according to the receiving device. The efficiency of the store experience is maximized for each user/device by sending only the data the device needs. Similarly, the protocol employed for the data transfer may be customized for the particular device, e.g., responses may be rendered in XML, JSON, Protocol Buffer, or the like.

### CROSS-REFERENCE TO RELATED APPLICATIONS

This application claims benefit of priority of U.S. Provisional Patent Application Ser. No. 61/352,737, filed Jun. 8, 2010, entitled “Flexible Data Structures And Protocols”, assigned to the assignee of the present application and herein incorporated by reference in its entirety.

### BACKGROUND

Current data structures and protocols tend to be specific to a given device. For example, a packed binary format is a common protocol for data transfer of an object, e.g., a game to be sold, to game consoles. However, fixed structures and protocols lead to fixed ways to view such object information, no matter whether the viewing client device is a portable game system or a large-screen television.

A related issue is the ability of the client device to accept and render the received data. For example, if a given call, e.g., for movie information, is changed in its response, a firmware update may be required. In the movie example, instead of returning just synopsis, actor information may be provided along with the synopsis. But if the receiving device, e.g., a media console, is incapable of rendering the extra information, a firmware update may be required, and the same are expensive in terms of cost, time, and goodwill to the user.

In addition, delivery of such data requires the establishment of a session between the client device and a session server. Once established, the session server can provide data requested by the client device. However, a large number of client devices conducting simultaneous sessions with the session server can lead to significant performance decreases due to the session server's inherent CPU and bandwidth limitations.

### SUMMARY

Implementations of the invention provide an API that supports a diverse range of products, and in particular diverse products of highly varying display and UI formfactors. A store experience, e.g., categories and products returned for a query, are customized according to the receiving device. In this way, the efficiency of the store experience is maximized for each user/device by sending only the data the device needs.

In more detail, a data template is established at the time of session creation, and this template is generally fixed for the remainder of the session. Once a data template is established, the set of fields to be returned is determined. In addition, resources can be delivered from a resource server, separate from the session server and potentially closer to the client, further relieving bandwidth and CPU demands on the session server. Moreover, even the resource server can be replaced or assisted in some cases by an edge cache server, such as an Akamai® server, for previously-provided resources that the edge cache server has stored.

However, use of a sessionless server requires that data template information be encoded in the URI (otherwise access to the session server would still be required), so that, e.g., a cell phone and a television are pointed to distinct and different resources. Implementations of the disclosed systems and methods provide for this encoding.

Another aspect of the invention concerns the data protocol, which is also encoded in the URI that represents the resource. The data contained inside the resource is separate from the protocol in which it is encoded, and the protocol may be configured to be flexible enough to be changed and yet the data still retrievable in any usable format.

In one aspect, the invention is directed toward a method of delivering data to a client device, including: receiving a request for data from a client device; determining a first parameter associated with a capability of the client device to receive data; determining a set of fields to be transmitted to the client device based on the parameter; and transmitting data based at least in part on the first parameter, where the determining a set of fields including comparing the first parameter to a look-up table, the look-up table associating a plurality of client devices with a plurality of fields, each of the plurality of client devices associated with a set of the plurality of fields.

Implementations of the invention may include one or more of the following. The method may further include authenticating the client device prior to the transmitting. The receiving a request may be performed by a session server and the transmitting data may include: transmitting information about the request from the session server to a resource server, and transmitting data based at least in part on the first parameter to the client device from the resource server. The receiving a request may be performed by a session server and the transmitting data may include: transmitting information about the request from the session server to an edge cache server and transmitting data based at least in part on the first parameter to the client device from the edge cache server. The method may further include: determining a second parameter associated with a communication protocol of the client device; determining an appropriate protocol for transmitting the set of fields to the client device based on the second parameter; and transmitting data based at least in part on the second parameter. The first parameter may be the same as the second parameter. The receiving a request may be performed by a session server and the transmitting data may include: transmitting information about the request from the session server to a resource server and transmitting data based at least in part on the second parameter to the client device from the resource server. The receiving a request may be performed by a session server and the transmitting data may include: transmitting information about the request from the session server to an edge cache server and transmitting data based at least in part on the second parameter to the client device from the edge cache server. The request for data may include a request for products listed in a category, or a parameter associated with a protocol appropriate for the client device, or a parameter associated with a capability of the client device to receive, manipulate, or display data, or a parameter associated with a subscription status associated with the client device.

In another aspect, the invention is directed towards a computer-readable medium, including instructions for causing a computer to perform the above method.

In another aspect, the invention is directed towards a system for delivering data to a client device, including: memory bearing computer-readable instructions capable of receiving information about a client device and capable of receiving a request for a resource; memory bearing computer-readable instructions capable of using the received information to form a data template for the client device; memory bearing computer-readable instructions capable of using the received information to choose a protocol for the device; and memory bearing computer-readable instructions capable of encoding the template and protocol information into a URL for the client device, the URL uniquely identifying the resource.

In an implementation, the method may include that the protocol is chosen from the group consisting of: XML, JSON, and protocol buffer.

In another aspect, the invention is directed towards a system for delivering data to a client device, including: an input module for receiving client device information and a client request for a resource; a templatting module for forming a data template based on the client device information; a protocol-setting module for choosing a protocol based on the client device information; and an encoding module for forming a URL that includes information about the data template and the protocol.

Implementations of the invention may include one or more of the following. The templatting module may further form the data template based on the requested resource. The protocol may be chosen from the group consisting of: XML, JSON, and protocol buffer.

In another aspect, the invention is directed towards a computer-readable medium, including instructions for causing a computer device to perform the following steps: receive a request for a resource from a client device; authenticate the client device; receive a first parameter from the client device, the first parameter associated with a capability of the client device to display the requested resource; create a data template for the client device based on the first parameter; choose a protocol for the client device; and transmit at least one URL to a content delivery network for delivery to the client device, the URL having encoded therein information about the data template and the protocol.

Implementations of the invention may include one or more of the following. The content delivery network may include a resource server or an edge cache server. The protocol may be chosen based on the first parameter or upon a received second parameter.

Implementations of the invention provide for a number of benefits. Data is treated efficiently, maximizing CPU efficiency and bandwidth. Expensive firmware updates are minimized; instead of having to update firmware to provide, e.g., a new field, the set of fields to be sent are determined within the data template at the time of session establishment. Consequently, new features can be developed for a device without affecting other devices already on the market.

Advantages of the invention may include one or more of the following. The improved system provides for flexible data templates and protocols so that different devices receive different combinations of data fields as appropriate for their user interfaces. The system and method provide a measure of backwards-compatibility: rather than relying on firmware updates to change the presentation of data, e.g., to add or change existing presented data, new data presentations ensue simply in the course of data template creation. In combination with the above, resource distribution and serving may be offloaded from a session server to a resource server or to an edge cache server or other non-session-based server, reducing CPU load and bandwidth requirements on the session server. Using the disclosed systems and methods, diverse store experiences may be supported, responsiveness to user needs may be increased, and data transfer may be made made more efficient. Additional advantages will be apparent from the description that follows, including the figures and claims.

### BRIEF DESCRIPTION OF THE DRAWINGS

Like reference numerals refer to like elements.

FIG. 1 illustrates varying formfactors for certain current client devices.

FIG. 2 illustrates a schematic layout of a system which may implement the systems and methods.

FIG. 3 is a flowchart illustrating an implementation of a method of the invention.

FIG. 4 is a sequence diagram illustrating an implementation of the invention.

FIG. 5 is a flowchart illustrating another implementation of a method of the invention.

FIG. 6 illustrates data flow for an NP object for various standards.

FIG. 7 illustrates exemplary data flow in the system for various standards.

FIG. 8 illustrates an exemplary computing environment and various memories that may be contained within. It will be understood that the memories may be combined in any number of ways, and the data shown need not be located in physically-separate memories.

FIG. 9 illustrates a modular view of an exemplary computing environment.

FIG. 10 illustrates an exemplary computing environment, e.g., that of the disclosed client systems.

### DETAILED DESCRIPTION

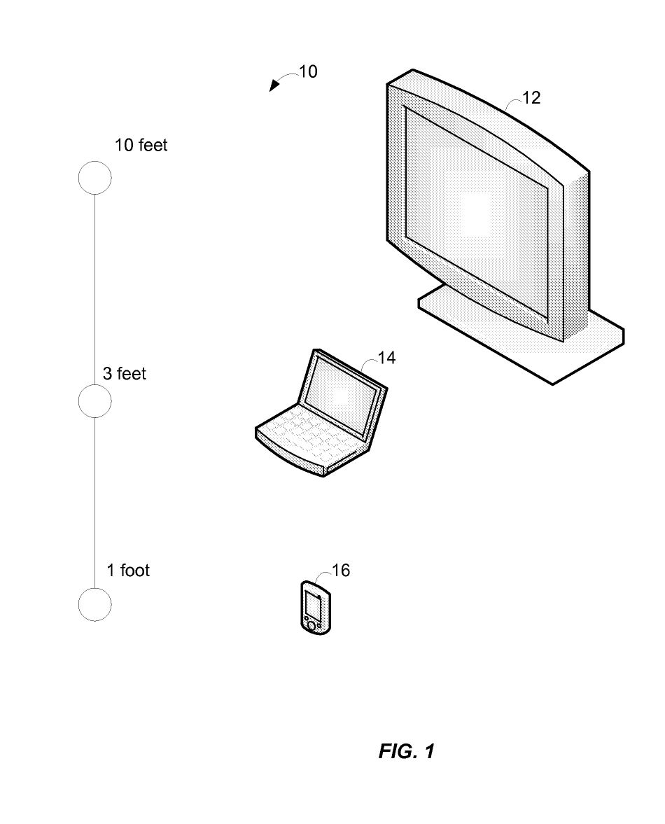

Referring to FIG. 1, an illustration is seen of a problem which is addressed by the disclosed systems and methods. Various devices are associated with various form factors, and such devices vary in their capability to render and display data. A large screen television 12 may be associated with a characteristic length scale for rendered data, a laptop computer 14 may be associated with another, and a portable game system 16 associated with still another. Other variations will also be seen. For example, a desktop computer may have a characteristic length scale between that of the laptop and the large screen television, while a tablet computer may have a characteristic length scale between that of the portable game system and the laptop. A mobile phone may have still another, although in many ways it may be similar to that of the portable game system 16.

The systems and methods disclosed allow the efficient transfer of an appropriate set of data for each of these client devices, as well as others. For example, if a user is using a cell phone, they may receive a subset of fields such as the name of the content item and a small image. However, a large-screen television may be provided with a long description of a movie, a list of actors, copyright information, the director, and a list of related movies. These fields may even include pictures of the actors and a set of recommendations for associated content. For actual content items, a cell phone view of a given television episode is different from the television view of the episode. As a result, they have different URIs, and the URI information may be encoded uniquely using the systems and methods described below.

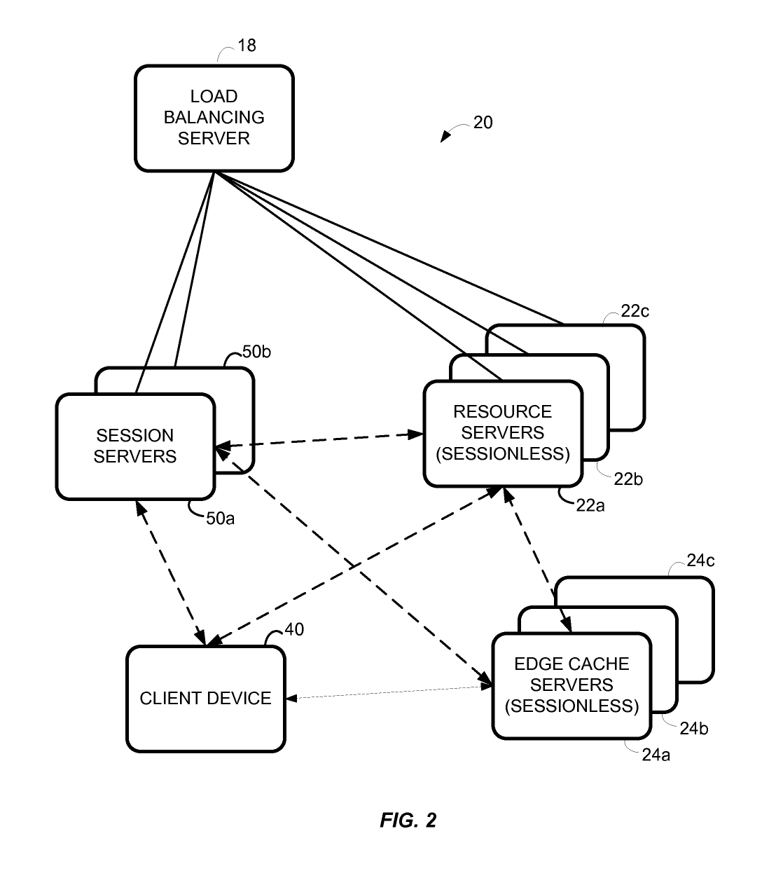

FIG. 2 illustrates a schematic layout of a system 20 which may implement the systems and methods. A client device 40 establishes a session with a session server 50. As these servers typically form part of a server farm, two session servers 50a and 50b are illustrated. A load-balancing server 18 is also illustrated, the load-balancing server generally employed to distribution workload evenly across the network as well as across networks distributed further afield.

The session server 50a generally employs a significant portion of its memory holding information about user sessions. The client device has affinity to the session server, meaning that once a connection has been made to the session server, every time a request is made from the load-balancing server 18, the user request will be addressed from the same session server.

The session server stores user states in memory. Any given session server may have several tens of thousands of sessions open, each requiring one to tens of kilobytes of data per session, and the total requiring gigabytes of data to be kept in memory at any one time. The user state includes information about what tasks the user has performed, what items are present in their shopping cart, and the like.

The necessity of keeping track of all of the user sessions leads to memory being a critical component of the session server. And because memory is a critical component, CPU use is also a critical component. In particular, if CPU use exceeds the capacity of the memory, an additional session server must be employed. This is a deleterious consequence because, in this eventuality, neither session server is employing their full amount of memory.

One way to reduce the load on the session server is to offload work the session server does that is not session-based. For example, if two users with similar client devices request to watch the same episode of a television program, then it would be duplicative to generate the view of the episode for each client device, especially at the level of the session server. For this and other reasons, one or more resource servers 22a, 22b, and 22c are provided and illustrated in FIG. 2. The resource servers 22a, 22b, and 22c may also form a portion of a server farm and thus multiple resource servers are shown.

The resource servers are generally responsible only for rendering resources. A resource may be, e.g., a product, a category, an image, or any other such file that is common for multiple viewings. The resource server is generally sessionless, meaning that a session server need not be accessed for the resource server to deliver or transmit data. By using the resource servers, the amount of CPU employed by the session servers is reduced, rendering the session servers desiredly memory-bound. Unlike the session servers, the resource servers have no associated affinity, and any given request may be responded to by any of the resource servers. In addition, every resource server is generally able to perform in this capacity as well as any other. It is noted in this connection that resource servers may be placed in virtually any desired location, and for this reason many are placed internationally in order to reduce latency by being geographically close to client devices.

In the same way, edge cache servers 24a, 24b, and 24c may be provided, which are also generally sessionless. Multiple edge cache servers 24a, 24b, and 24c are illustrated to indicate that many of these are generally disposed in various locations. Such edge cache servers 24a, 24b, and 24c are generally operated by third parties, such as Akamai®, and the same provide a load-balancing capacity to the rest of the network. In particular, the edge cache servers 24a, 24b, and 24c may cache resources that the resource servers 22a, 22b, and 22c have previously provided to client devices 40.

The URLs that are served by the resource servers 22a, 22b, and 22c and the edge cache servers 24a, 24b, and 24c are edge-cacheable, meaning that the data contained within the resource is uniquely identified by the resource's URL. A call to any given URL therefore returns identical data. The same is not necessarily true of the session servers 50a and 50b, which may provide a different response to the same URL call depending on, e.g., a user's login status.

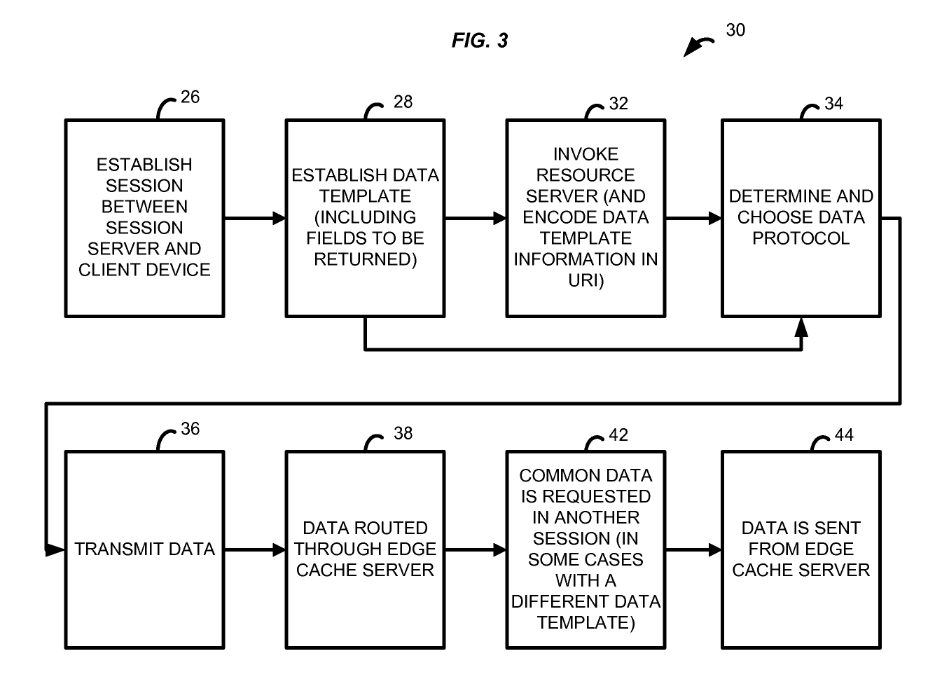

Referring to FIG. 3, which is a flowchart illustrating an implementation of a method 30 of the invention, a first step in the method is to establish a session between a session server and a client device (step 26). Generally, this will involve some degree of user login and authentication. The next step is to establish a data template (step 28), which may include the establishment of a set of data fields to be returned upon request from the client device. The establishment of the data template is described in greater detail below.

A next step, which need not be performed in every implementation, is to invoke a resource server (step 32). In this case, the resource server is not generally aware of the data template that has been established. Moreover, to require the resource server to call on the session server for such information is cumbersome. Consequently, the data template information is encoded in the URI that is sent to the resource server, for subsequent transmission to the client device. As not every implementation of the invention requires this step, a line is also shown from the establishment of the data template to a step of the determination of the data protocol.

A next step, as noted above, is to determine, choose, and encode a data protocol (step 34). In this regard, it is noted that different products and different devices have different protocols for the way in which they send and receive data. For example, a game console built on a C-based language may operate well with C-based structs. It may further operate well with 32-bit or 64-bit numbers, but may require a conversion step if faced with a different type of number. Moreover, client devices may employ a specific data format to meet their needs, e.g., TLV. But many client devices exist that are not efficient in reading such files or that are incapable of reading such files. For example, certain client devices, e.g., certain phones and PCs, operate well with JSON or XML. Other client devices operate well with protocol buffers. By choosing the proper protocol to accommodate the client device, the client device receives data in the format on which the same may operate most effectively and efficiently. And importantly this information may be encoded in the URI that represents the requested resource.

One way of implementing this protocol-setting is by consolidating all data-protocol-specific processing into a filter. New protocols may then simply be the implementation of a single filter. This technique has certain advantages such as speed of development, the ability to employ existing parsers on platforms, and the ability to standardize object-to-protocol translation to further speed new development. However the protocol is set, once established, data corresponding to the requested resource may then be transmitted (step 36).

In some cases, data is provided which is routed through an edge cache server (step 38). In these cases, the edge cache server may store a copy of the data for future transmission. For example, the data may correspond to a content item like the latest episode of a television series. In this case, it may be expected that multiple users will request the same content item (step 42), and the same may simply be directed to be sent from the edge cache server (step 44) instead of the resource server.

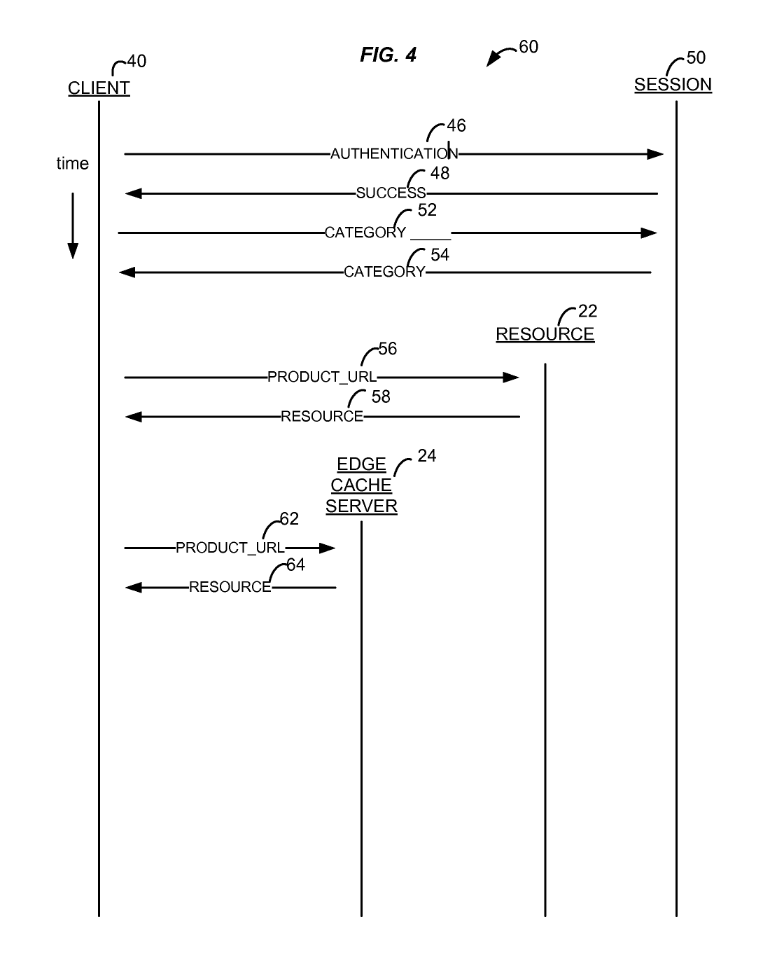

FIG. 4 illustrates a sequence diagram for a series of actions in which a user requests information about a product. The sequence diagram 60 initially illustrates communications between a client 40 and a session server 50. The topmost action is the earliest in time, and subsequent actions are placed sequentially below.

The first action 46 is that the client device requests authentication from the session server. The session server may report back success or failure, and a success action 48 is illustrated in the diagram. Subsequent steps illustrate how the client and session server establish the template, and in this case a product template is illustrated. In this example, the product template may include fields such as the product name and the product image.

For example, the client 40 may place a request 52 for a category of products. This request may be a default request for the root category of the store. The session server 50 may then return back category information 54. The category information returned may include fields such as the category name, additional metadata about that category that may be appropriate for display to the user, and importantly may include a list of child URLs, e.g.,

http://resource_server/product/product_id/template_id.ext or equivalently http://resource_server/product/<P_id>/<temp>.<ext>.

The data template established, as noted above, may have been such that the product information includes a name and an image. The data template may further note, e.g., that product information should be sent in the JSON format because that is easiest for the given client device to parse. In this example, the product URL would look like http://resource_server/product/<P_id>/<temp>.json.

In other words, in this case, it is the JSON URL that is returned because a data template was established, as part of an initial determination of the user's state, at the time of session creation indicating that the client device requests JSON. The JSON protocol information is encoded into the URL as noted above so that when the same is read by the resource server, the correct data and format may be provided without requiring access to the session server.

The above was an example for one product. In general, a number of such URLs will be created for each of the products in the category. Once such encoded URLs are created, subsequent requests by the client device, such as for a particular product URL 56, may be made to the resource server, shown in the sequence diagram 60 as a resource 22, and a resource 58 may be returned therefrom. The session server is thus free for other purposes.

Because the resource was uniquely identified by the URL, even the resource server 22 need not be employed if an edge cache server 24 has such product URL information stored. That is, if a request for product URL 62 is made by a client 40, a search may be made within the edge cache server 24 to determine if the same has generated the resource, i.e., product URL, for another client device previously. If the edge cache server 24 has such data stored, it may return the data to the client device without burdening even the resource server. Again, the same is possible because of the uniqueness of the URL and because the template and protocol information are encoded within the URL.

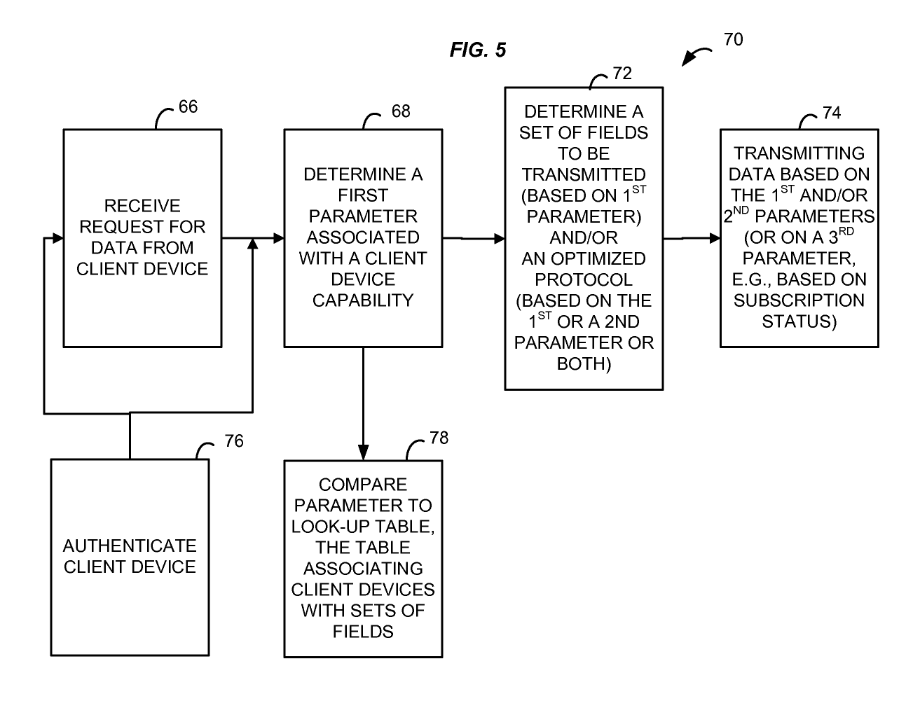

FIG. 5 is a flowchart illustrating another method 70 that may implement the invention. A first step is the reception of a request for data from a client device (step 66). This step may include login or authentication procedures as disclosed above (step 76).

A next step is to determine a first parameter associated with a client device capability (step 68). The client device capability may be related to processing power, display area, user interfaces, operating systems, memory capabilities, storage capabilities, communication protocols, or indeed any variable which bears on the ability of the device to receive, manipulate, or display data. One way of determining the first parameter is to compare a received parameter to a lookup table, the lookup table associating various client devices with respective sets of fields. An exemplary implementation of this is provided below where various client devices are assigned indices which correspond to appropriate fields.

A next step is the determination of a set of fields to be transmitted, an optimal protocol in which to communicate the data, or both (step 72). In the former, the set of fields chosen is commensurate with the establishment of the data template. In the latter case, the optimal protocol may be based on the first parameter or on a second parameter, or on both. In the case where a second parameter is employed, the parameter may be chosen to be particularly indicative of data protocols appropriate for the device.

A next step is the transmission of data based on the first or the second parameters, or both (step 74). It is also noted that the transmission of data may be further based on a third parameter, e.g., one based on another aspect, such as a subscription status.

As noted above, it is important to encode the template information, e.g., <temp>, in a way that may be decoded and used by the resource server. A template fingerprint is created that encodes all of the information in a small number of bytes and in a way that is readable by both the session server and the resource server. A list is established of all the possible fields that could be generated in a given application:

TABLE I

| Possible fields | Game Console | Phone1 | Phone2 |
|---|---|---|---|
| Name | 1 | 1 | 1 |
| Image | 1 | 1 | 1 |
| Description | 1 | 0 | 1 |
| Actor list | 1 | 0 | 0 |

Table 1 illustrates such a list with just a few representative fields. Typically, there may be hundreds of such fields. Any given data template fingerprint may be encoded in binary and, e.g., converted to ASCII and stored in just a small number of letters. For example, the game console above could be encoded as 1111, the Phone1 template could be encoded as 1100, and the Phone2 template could be encoded as 1110. In this way, all the fields requested at the time of the original session creation and template establishment may be encoded in a simple way and converted into, e.g., a few letters, which uniquely identifies what should be rendered for the given device.

As noted above, this also reduces problematic issues caused by certain firmware updates, where the updates cause a variation in the fields displayed on a client device from version to version. With implementations of the disclosed systems and methods, if a user downloads a new firmware update, the same may then establish a new session and cause the creation of a new template. However, a user who does not download the new firmware update will still be able to access and display requested data, although generally in a way distinct from the first user. In some cases, a distinct URL will be accessed, but the user experience will continue to be as the user intends. In this connection, it is noted that certain users may have different phones and may see categories completely differently, but products may be seen in exactly the same way. The system and method may take advantage of this common templatting, and having already rendered the product view for one phone, may send the same packet to the other.

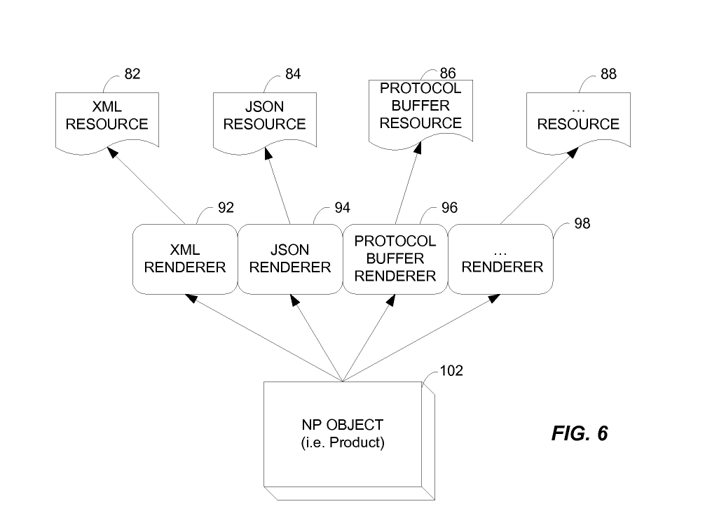

FIG. 6 illustrates a data flow diagram 80 for an NP object for various standards, illustrating how one object may be communicated via various protocols. An object 102 is illustrated that may be rendered in a number of ways, e.g., by XML renderer 92, by JSON renderer 94, by a protocol buffer renderer 96, or by a generic renderer 98. The rendered object then appears as XML resource 82, JSON resource 84, protocol buffer resource 86, or generic resource 88, respectively.

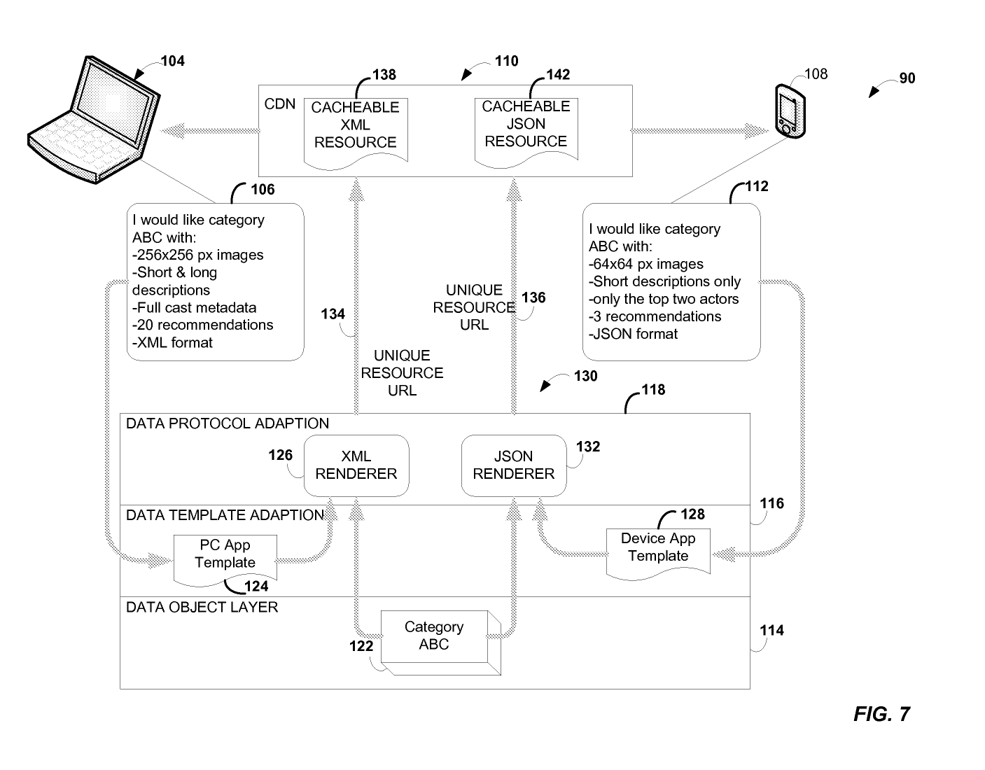

FIG. 7 illustrates another exemplary data flow diagram 90 within the system for various standards. An exemplary personal computer 104, shown as a laptop, is illustrated making a request 106 for a category ABC. A smaller device 108, which may be, e.g., a portable gaming console or mobile phone, is illustrated making a request 112 for the same category. Each creates a session with a session server 130, and a suitable data template is created for each. For example, a PC template 124 is created for the computer 104, while a template 128 is created for the portable system. It is noted that these templates may be created within a data template adaptation layer 116 within the logical structure of the session server 130. A data object layer 114 is below the data template adaptation layer 116, and the same results in the creation or instantiation of an object corresponding to category ABC upon the request of a client device, e.g., upon requests 106 or 112.

In addition to allowing for flexible data templatting, a data protocol adaptation layer 118 within the session server 130 allows for the flexible setting of an appropriate protocol for a resource as determined by the capabilities of the requesting client device and as illustrated in FIG. 6 above. In FIG. 7, where the request 106 notes an appropriate format as being XML, an XML renderer 126 may be employed. Where the request 112 notes an appropriate format as being JSON, a JSON renderer 132 may be employed. Each results in a unique resource URL being associated with the resource. In this example, a URL 134 is associated with the XML resource, and a URL 136 is associated with the JSON resource. A content delivery network 110 is illustrated, which may include the above noted resource server, the above noted edge cache server, or other such content delivery network component. The content delivery network 110 is illustrated as storing the cacheable XML resource 138 and the cacheable JSON resource 142. The same are delivered to the computer 104 and the device 108, respectively, in response to respective requests 106 and 112. In addition, the same may be stored to accommodate future requests.

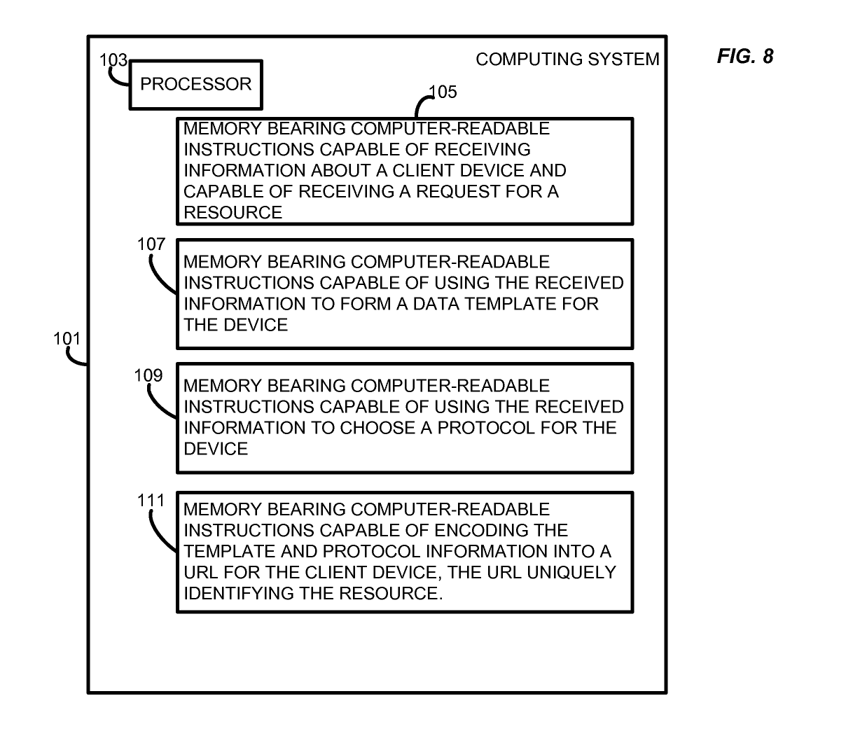

FIG. 8 illustrates a first implementation of a computing system 101 in which the invention may be implemented. The computing system 101 includes a processor 103. The computing system 101 also includes memory 105 bearing computer readable instructions capable of receiving information about a client device and which is further capable of receiving a request for a resource. The computing system 101 further includes memory 107 bearing computer readable instructions capable of using the received information to form a data template for the client device. Typically, these computer readable instructions will use the received information and base the template on the ability of the client device to receive, manipulate, and display the various fields associated and available from the resource. The computing system 101 further includes memory 109 bearing computer readable instructions capable of using information about the client device to choose a suitable communication protocol and format in which the resource information should be provided to the client device. This information may be the same as that employed to form the data template or additional information may be received for this purpose. The computing system 101 further includes memory 111 bearing computer readable instructions capable of encoding the template and protocol information into a URL for the client device, the URL uniquely identifying the resource. This URL may be delivered to a resource server or other content delivery network component for subsequent transmission to the client device, and the same may be employed by the client device to display the resource associated with the URL.

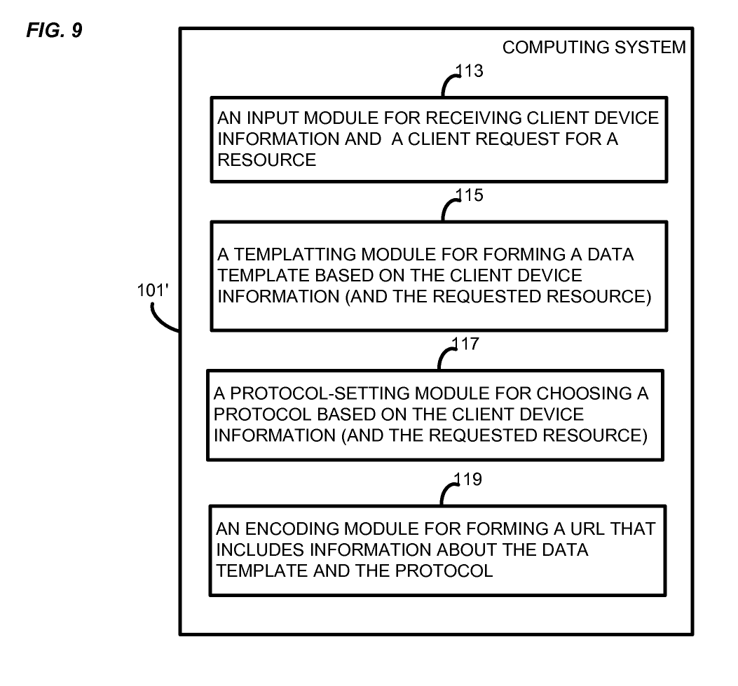

FIG. 9 illustrates an alternative view of the computing system 101′. In this implementation, the computing system includes an input module 113 for receiving client device information and a client request for a resource. A templatting module 115 takes the client device information and the resource request and forms a data template based on the same. In some cases, the templatting module may form the data template solely based on client device information. The computing system 101′ further includes a protocol setting module 117 for choosing a protocol based on the client device information, and further based in some cases on the requested resource. The computing system may further include an encoding module 119 for forming a URL which includes aspects of the chosen data template and protocol. This URL is then employed by the client device to access the resource with a set of fields and a protocol appropriate to the client device. Other modules may also be employed as will be seen based on other functionality of the system.

In implementing the above systems and methods, an appropriate API specification supporting the same may include the following.

### SetEntityTemplate

In this connection it is noted that the information returned for a get product or get category request is generally minimal. By default, a category and product request will return a very thin product that only contains the requested entity's ID. In order to retrieve a more useful collection of entity data for the device, an entity template is established that defines the information to be returned on future requests. All calls to setEntityTemplate may be made under an established, authorized session. Product and category calls made within this session may use these templates to format the data objects returned.

An exemplary setEntityTemplate URL may be as follows:

http://<envHostName>/setEntityTemplate.action
setEntityTemplate takes the following parameters:

| Parameter | | | |
|---|---|---|---|
| Key | Description | Required | Values |
| entityTemplate | A string that | Y | A string with the |
| | describes an | | following format: |
| | entityTemplate | | entityType: <field1>, |
| | that will be used | | <field2>, . . . <fieldn> |
| | for future | | |
| | communication | | |
| | on the session. | | |

Additionally, it is possible to set multiple entityTemplates with a single request. In this case, multiple entityTemplates are included in the same request.

The following entities may have object templates defined for them:

Entity Type List

| | | Typical variables |
|---|---|---|
| Key | Description | included in template |
| product | A large product object that is the return | Name, imageUrl, |
| | type of /Product/<productID> requests | ageLimit, ratingImage, |
| | | longDescription |
| thinProduct | A small product object that is returned in | Name, imageURL, |
| | the children section of | shortDescription |
| | /Category/<categoryID> requests and | |
| | /Search/<QueryTerms> requests | |
| Category | A large category object that is the return | Name, imageURL, |
| | type of /Category/<categoryID> requests. | ageLimit, |
| | | longDescription |
| thinCategory | A small category object that is returned in | Name, imageURL, |
| | the children section of | shortDescription |
| | /Category/<categoryID> requests | |
| CategoryChild | The object that represents a product or | Name, ImageURL |
| | category when listed as children of a | |
| | category. | |

### Set Entity Template Return Object

| Result | | Always | | |
|---|---|---|---|---|
| Key | Description | Present | Values | |
| result | The result of the set | Y | SUCCESS | The templates |
| | entity template | | | defined in the |
| | attempt. | | | request will now be |
| | | | | used for the |
| | | | | remainder of the |
| | | | | session |
| | | | BAD_ENTITY | One or more entities |
| | | | | in the request was |
| | | | | not recognized by |
| | | | | the server. |
| | | | BAD_FIELD | One or more fields |
| | | | | in the request was |
| | | | | not recognized by |
| | | | | the server, or not |
| | | | | allowed on the entity |
| | | | | it was requested on. |
| | | | | Details will be |
| | | | | provided in the |
| | | | | detail section. |
| | | | UNKNOWN_ERROR | An unknown error |
| | | | | has occurred. |

| | | | |
|---|---|---|---|
| detail | Additional | N | This section may include stack trace |
| | information may be | | information, or other debugging output |
| | included in this | | |
| | section to aid | | |
| | debugging | | |

### EXAMPLES

Below is an example of a setEntityTemplate request that defines the data that would be suitable for a 10-foot (TV) type device for video products:

httplkenvHostName>/setEntityTemplate.action?entityTemplate:product&produc tId,name,imageURL,studioName,ratingImage,longDescription,actorList,director,releaseY ear,copyrightInformation

Below is an example of a setEntityTemplate request that defines the data that would be suitable for a 1-foot (mobile phone) type device for video products:

http://<envHostName>/setEntityTemplate.action?entityTemplate=product:productId,nam e,imageURL,ratingImage,shortDescription,copyrightInformation
The 1-foot device requests only the information that it will display, reducing bandwidth and memory requirements.

Below is an example of multiple templates being defined in the same request:

http://<envHostName>/setEntityTemplate.action?entityTemplate=product:include

Fields=productId,name,imageURL&entityTemplate=category:categoryId,name,imageUR
L,shortDescription

### Response Examples

{″result″:″SUCCESS″}
{″result″:″BAD_FIELD″,”detail”:”field: categoryId is not allowed

on entity:product”}
...

### Data Protocol Flexibility

The API can render responses in XML, JSON and Protocol Buffer, as well as other formats. In each of these cases, the data objects will have the same name and have a common nesting structure. For example, an authenticate call may return the following responses:

JSON

| {″result″:″AUTHENTICATION_SUCCESS″, | |
|---|---|
| “account”:{ | “accountId”:”123456789”, |

“handle”:”userhandle123”,

“emailAddress”:”user@user.org”,
“countryCode”:”US”,
“languageCode”:”en”,
“accountLevel”:”1”,
“minCharge”:”$0”,
“maxWalletBallance:”$10.00”,
“age”:”40”
}

}

XML

<response>

<field name=”response”>AUTHENTICATION_SUCCESS</field>
<object name=“account”>

<field name=”accountId”>123456789</field>
<field name=”handle”>userhandle123</field>
<field name=”emailAddress”>user@user.org</field>
<field name=”countryCode”>US</field>
<field name=”languageCode”>en</field>
<field name=”accountLevel”>1</field>
<field name=”minCharge”>$0</field>
<field name=”maxWalletBallance>$10.00</field>
<field name=”age”>40</field>

</object>

</response>

PROTOCOL BUFFER

binary stream

Systems and methods have been disclosed that allow for flexible data templatting and flexible protocols to more efficiently provide access to online resources. While the invention has been described in the context of a storefront with products, other implementations of the systems and methods may be used for efficiently enabling access to any online resource.

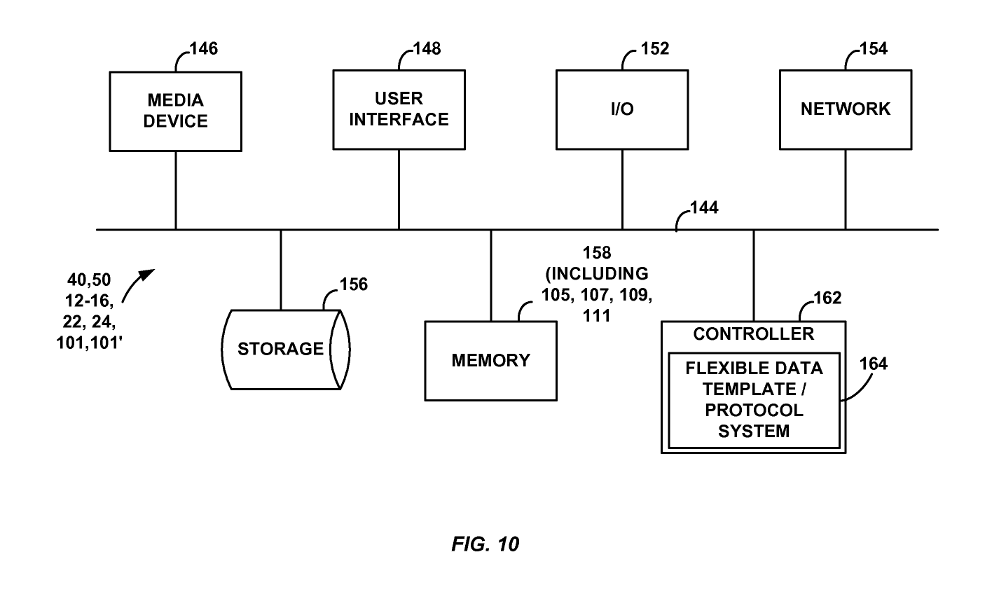

One implementation includes one or more programmable processors and corresponding computing system components to store and execute computer instructions, such as to execute the code that provides the flexible data templatting and protocol-setting functionality. For example, and referring to FIG. 10, a representation of an exemplary computing environment is illustrated, e.g., any of systems 40, 50, 12-16, 22, 24, 101, or 101′.

In FIG. 10, the exemplary computing environment includes a controller 162, a memory 158, storage 156, a media device 146, a user interface 148, an input/output (I/O) interface 152, and a network interface 154. These components are interconnected by a common bus 144. Alternatively, different connection configurations can be used, such as a star pattern with the controller at the center.

The controller 162 includes the programmable processor and controls the operation of the computing environment and its components. The controller 162 loads instructions from the memory 158 or an embedded memory controller (not shown) and executes these instructions to control the system. In its execution, the controller 162 may provide the flexible data templatting and protocol-setting system as, in part, a software system. Alternatively, this service can be implemented as separate components in the controller 162 or elsewhere in the computing environment.

The memory 158 stores data temporarily for use by the other components of the computing environment. In one implementation, memory 158 is implemented as RAM. In other implementations, memory 158 also includes long-term or permanent memory, such as flash memory and/or ROM. Other memories may also be employed as will be seen based on other functionality of the system.

The storage 156 stores data temporarily or long-term for use by other components of the computing environment, such as for storing data used by the flexible data templatting and protocol-setting system. In one implementation, storage 156 is a hard disc drive or a solid state drive. The storage 156 may include information that, during use, is loaded into one or more of the memories noted above.

The media device 146 receives removable media and reads and/or writes data to the inserted media. In one implementation, the media device 146 is an optical disc drive or disc burner, e.g., a writable Blu-ray® drive.

The user interface 148 includes components for accepting user input from the user of the computing environment and presenting information to the user. In one implementation, the user interface 148 includes a keyboard, a mouse, audio speakers, and a display. The controller 162 uses input from the user to adjust the operation of the computing environment.

The I/O interface 152 includes one or more I/O ports to connect to corresponding I/O devices, such as external storage or supplemental devices, e.g., a printer or a PDA. In one implementation, the ports of the I/O interface 152 include ports such as: USB ports, PCMCIA ports, serial ports, and/or parallel ports. In another implementation, the I/O interface 152 includes a wireless interface for wireless communication with external devices.

The network interface 154 includes a wired and/or wireless network connection, such as an RJ-45 or “WiFi” interface (802.11) supporting an Ethernet connection. Numerous other types of network connections will be understood to be possible, including WiMax, 3G or 4G, 802.15 protocols, 802.16 protocols, satellite, Bluetooth®, or the like.

The computing environment includes additional hardware and software typical of workstations, e.g., power, cooling, operating system, though these components are not specifically shown in the figure for simplicity. In other implementations, different configurations of the workstation can be used, e.g., different bus or storage configurations or a multi-processor configuration.

Various illustrative implementations of the present invention have been described. However, one of ordinary skill in the art will recognize that additional implementations are also possible and within the scope of the present invention. For example, the system and method may apply to any distributed system whereby online resources are delivered to requesting users. The session server may be combined with the resource server (other combinations are also possible). Other variations will also be understood given these teachings.

Accordingly, the present invention is not limited to only those implementations described above.

1. A method of delivering data to a client device, comprising:
a. receiving a request for data from a client device;
b. determining a first parameter associated with a capability of the client device to receive data;
c. determining a set of fields to be transmitted to the client device based on the parameter; and
d. transmitting data based at least in part on the first parameter,
e. wherein the determining a set of fields including comparing the first parameter to a look-up table, the look-up table associating a plurality of client devices with a plurality of fields, each of the plurality of client devices associated with a set of the plurality of fields.

2. The method of claim 1, further comprising authenticating the client device prior to the transmitting.

3. The method of claim 1, wherein the receiving a request is performed by a session server and the transmitting data includes:
a. transmitting information about the request from the session server to a resource server; and
b. transmitting data based at least in part on the first parameter to the client device from the resource server.

4. The method of claim 3, wherein the receiving a request is performed by a session server and the transmitting data includes:
a. transmitting information about the request from the session server to an edge cache server; and
b. transmitting data based at least in part on the first parameter to the client device from the edge cache server.

5. The method of claim 1, further comprising:
a. determining a second parameter associated with a communication protocol of the client device;
b. determining an appropriate protocol for transmitting the set of fields to the client device based on the second parameter; and
c. transmitting data based at least in part on the second parameter.

6. The method of claim 5, wherein the first parameter is the same as the second parameter.

7. The method of claim 5, wherein the receiving a request is performed by a session server and the transmitting data includes:
a. transmitting information about the request from the session server to a resource server; and
b. transmitting data based at least in part on the second parameter to the client device from the resource server.

8. The method of claim 7, wherein the receiving a request is performed by a session server and the transmitting data includes:
a. transmitting information about the request from the session server to an edge cache server; and
b. transmitting data based at least in part on the second parameter to the client device from the edge cache server.

9. The method of claim 1, wherein the request for data includes a request for products listed in a category.

10. The method of claim 1, wherein the request for data includes a parameter associated with a protocol appropriate for the client device.

11. The method of claim 1, wherein the request for data includes a parameter associated with a capability of the client device to receive, manipulate, or display data.

12. The method of claim 1, wherein the request for data includes a parameter associated with a subscription status associated with the client device.

13. A computer-readable medium, comprising instructions for causing a computer to perform the method of claim 1.

14. A system for delivering data to a client device, comprising:
a. memory bearing computer-readable instructions capable of receiving information about a client device and capable of receiving a request for a resource;
b. memory bearing computer-readable instructions capable of using the received information to form a data template for the client device;
c. memory bearing computer-readable instructions capable of using the received information to choose a protocol for the device; and
d. memory bearing computer-readable instructions capable of encoding the template and protocol information into a URL for the client device, the URL uniquely identifying the resource.

15. The system of claim 14, wherein the protocol is chosen from the group consisting of:
XML, JSON, and protocol buffer.

16. A system for delivering data to a client device, comprising:
a. an input module for receiving client device information and a client request for a resource;
b. a templatting module for forming a data template based on the client device information;
c. a protocol-setting module for choosing a protocol based on the client device information; and
d. an encoding module for forming a URL that includes information about the data template and the protocol.

17. The system of claim 16, wherein the templatting module further forms the data template based on the requested resource.

18. The system of claim 16, wherein the protocol is chosen from the group consisting of:
XML, JSON, and protocol buffer.

19. A computer-readable medium, comprising instructions for causing a computer device to perform the following steps:
a. receive a request for a resource from a client device;
b. authenticate the client device;
c. receive a first parameter from the client device, the first parameter associated with a capability of the client device to display the requested resource;
d. create a data template for the client device based on the first parameter;
e. choose a protocol for the client device; and
f. transmit at least one URL to a content delivery network for delivery to the client device, the URL having encoded therein information about the data template and the protocol.

20. The system of claim 19, wherein the content delivery network includes a resource server or an edge cache server.

21. The system of claim 19, wherein the protocol is chosen based on the first parameter or upon a received second parameter.
